(19) United States
(12) Patent Application Publication
(10) Pub. No.: US 2007/0118824 A1
(43) Pub. Date: May 24, 2007

(54) METHODS, SYSTEMS, AND COMPUTER PROGRAM PRODUCTS FOR IMPROVING YIELD IN INTEGRATED CIRCUIT DEVICE FABRICATION AND RELATED DEVICES

(75) Inventors: Choel-hwyi Bae, Gyeonggi-do (KR); Sang-deok Kwon, Seoul (KR); Gwang-hyeon Baek, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/560,006

(22) Filed: Nov. 15, 2006

(30) Foreign Application Priority Data
Nov. 23, 2005 (KR) 10-2005-112549

(51) Int. Cl. G06F 17/50; G06F 19/00

(52) U.S. Cl. 716/5; 700/109

(57) ABSTRACT

A method of improving yield in integrated circuit device fabrication includes calculating a fault rate for a design rule based on a plurality failure rates for a corresponding plurality of Design Of Experiment (DOE) rule values and based on numbers of features in a layout of interest corresponding to ones of the plurality of DOE rule values. The layout of interest is corrected based on the fault rate for the design rule. Related systems and devices are also discussed.

### CROSS-REFERENCE TO RELATED APPLICATION

This application claims priority from Korean Patent Application No. 10-2005-112549 filed on Nov. 23, 2005, in the Korean Intellectual Property Office, the disclosure of which is incorporated herein by reference in its entirety.

### FIELD OF THE INVENTION

The present invention relates to integrated circuit devices, and more particularly, to methods and systems for improving integrated circuit device fabrication and related devices.

### BACKGROUND OF THE INVENTION

With the rapid increase in the technological level and the complexity of design of integrated circuit devices, interest in Design For Manufacturability (DFM) is increasing. In particular, in order to realize yield enhancement, a recommended rule for DFM methods may be developed. The recommended rule may have a value that falls within and/or is “backed-off” from a minimum design rule by a predetermined amount.

More particularly, the design of the layout of an integrated circuit device may be dependent on a minimum design rule value (or ground rule value). The minimum design rule value may, for example, represent the limitation of resolution in current photo-processing, and, in particular, may refer to a minimum space interval, a minimum overlap area, or the like between various masks and/or within a mask used in the fabrication of the integrated circuit device. However, when a current processing technology does not satisfy the minimum design rule value, the yield may be enhanced using a recommended rule value that is slightly higher than the minimum design rule value in the layout design of an integrated circuit device.

### SUMMARY OF THE INVENTION

According to some embodiments of the present invention, a method of improving yield in integrated circuit device fabrication includes calculating a fault rate for a design rule based on a plurality of failure rates for a corresponding plurality of Design Of Experiment (DOE) rule values and based on numbers of features in a layout of interest corresponding to ones of the plurality of DOE rule values. For example, the fault rate may be programmatically calculated. The layout of interest is corrected based on the fault rate for the design rule.

According to further embodiments of the present invention, a system for improving yield in integrated circuit device fabrication includes a fault rate provision unit and a correction unit. The fault rate provision unit is configured to calculate a fault rate for a design rule based on a plurality of failure rates for a corresponding plurality of Design Of Experiment (DOE) rule values and based on numbers of features in a layout of interest corresponding to ones of the plurality of DOE rule values. The correction unit is configured to suggest correction for the layout of interest based on the fault rate for the design rule.

In accordance with some embodiments of the present invention, a method of enhancing the yield of integrated circuit devices may include determining a plurality of Design Of Experiment (DOE) rule values for a design rule; measuring a plurality of DOE rule value-based failure rates; counting numbers of features corresponding to each of the DOE rule values in a layout of interest; providing a fault rate of the design rule using the DOE rule value-based failure rates and the numbers of features; and correcting the layout of interest using the fault rate of the design rule.

Furthermore, in accordance with other embodiments of the present invention, a system for enhancing the yield of integrated circuit devices may include a first storage unit configured to store a plurality of DOE rule values for a design rule; a second storage unit configured to store a plurality of DOE rule value-based failure rates; a counter configured to count numbers of features corresponding to each of the DOE rule values in a layout of interest; a fault rate provision unit configured to provide a fault rate of the design rule using the DOE rule value-based failure rates and the numbers of features; and a correction unit configured to suggest correction for the layout of interest using the fault rate of the design rule.

### BRIEF DESCRIPTION OF THE DRAWINGS

FIG. 1 is a flowchart illustrating operations for enhancing the yield of integrated circuit devices according to some embodiments of the present invention;

FIGS. 2A to 2D are graphs further illustrating the operations for enhancing the yield of FIG. 1;

FIG. 3 is a flowchart illustrating operations for enhancing the yield of integrated circuit devices according to other embodiments of the present invention;

FIG. 4 is a flowchart illustrating operations for enhancing the yield of integrated circuit devices according to further embodiments of the present invention;

FIG. 5 is a flowchart illustrating operations for enhancing the yield of integrated circuit devices according to still other embodiments of the present invention;

FIG. 6 is a flowchart illustrating operations for enhancing the yield of integrated circuit devices according to still further embodiments of the present invention;

FIG. 7A is a flowchart illustrating operations for enhancing the yield of integrated circuit devices according to yet other embodiments of the present invention;

FIG. 7B is a graph further illustrating the operations for enhancing the yield of FIG. 7A; and

FIG. 8 is a block diagram illustrating a system for enhancing the yield of integrated circuit devices according to some embodiments of the present invention.

### DETAILED DESCRIPTION OF EMBODIMENTS OF THE INVENTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The present invention is described hereinafter with reference to flowchart and/or block diagram illustrations of systems, methods, and computer program products in accordance with some embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, or semiconductor system, apparatus, and/or device. More specific examples (a nonexhaustive list) of the computer-readable medium would include the following: a portable computer diskette, a random access memory (RAM), a read-only memory (ROM), an erasable programmable read-only memory (EPROM or Flash memory), and a compact disc read-only memory (CD-ROM). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Computer program code for programmatically carrying out operations of systems, methods, and computer program products according to some embodiments of the present invention discussed below may be written in a high level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

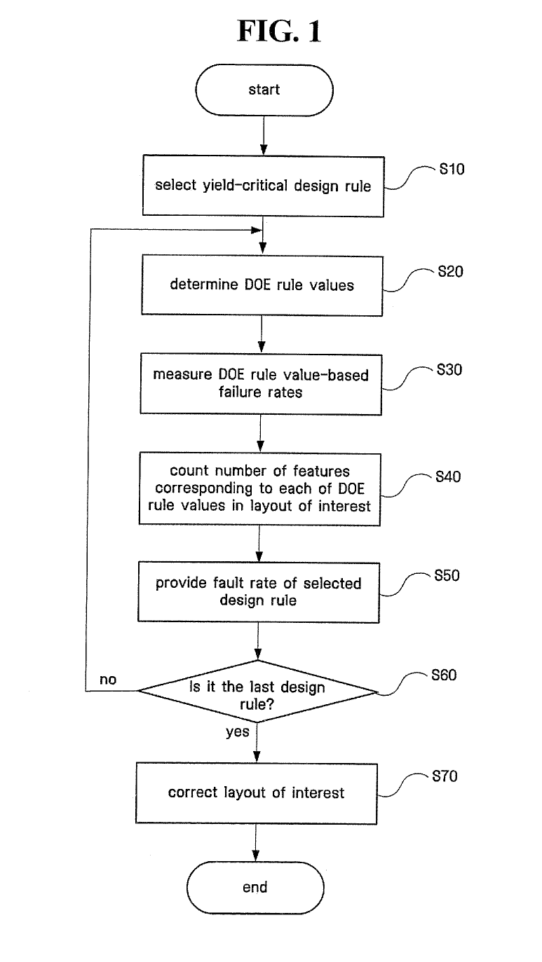

Operations for enhancing the yield of integrated circuit devices according to various embodiments of the present invention are described below with reference to FIGS. 1 to 7B.

FIG. 1 is a flowchart illustrating operations for enhancing yield in integrated circuit device fabrication according to some embodiments of the present invention.

Referring now to FIG. 1, yield-critical design rules (for example, m design rules, where m≧1), which may decisively affect yield, are selected from among a plurality of design rules in a set of design rules at Block S10. More particularly, in order to design the layout of an integrated circuit device, a set of design rules is used. The set of design rules includes a plurality of design rules, for example, the space between two lines, the width of a line, the minimum width of an active area, the minimum enclosure of a contact or a via, or the like. The yield-critical design rules, that is, the design rules that may decrease the yield of a wafer if not strictly followed, are selected from among the plurality of design rules at Block S10. However, it is to be understood that, in some embodiments, the operations following Block S10 may be applied to other and/or all design rules included in the set of design rules, in addition to the yield-critical design rules.

Next, one or more Design Of Experiment (DOE) rule values (for example, n DOE rule values, where n≧1) for the selected design rule are determined at Block S20. More particularly, the plurality of DOE rule values may be taken at increments in a predetermined interval from a Minimum Design Rule value (MDR). The predetermined interval may be a design grid or a multiple of the design grid. For example, when the selected design rule is the space between two lines, the minimum design rule value may be 0.04 μm, the design grid may be 0.01 μm, and the determined DOE rule values may be values acquired at increments of 0.01 μm between 0.04 μm and 0.11 μm. In other words, the DOE rule values may be experimental values taken at predetermined increments from the MDR. Meanwhile, the largest (that is, 0.11 μm) of the plurality of DOE rule values may be a value that allows the space between two lines to be sufficiently wide to generate few failures and can be expected from past experience.

Thereafter, a plurality of DOE rule value-based failure rates are measured at Block S30. In particular, test patterns representing the selected design rule are formed on a wafer for each of the plurality of DOE rule values. The number of the test patterns in which failure occurs is counted for each of the plurality of DOE rule values. For example, when the space between lines is the selected design rule, a predetermined number of test patterns is formed for each of the plurality of DOE rule values (in increments of 0.01 μm, from 0.04 μm to 0.11 μm). The number of the test patterns in which failure occurs is counted for each of the plurality of DOE rule values, and the DOE rule value-based failure rates are calculated.

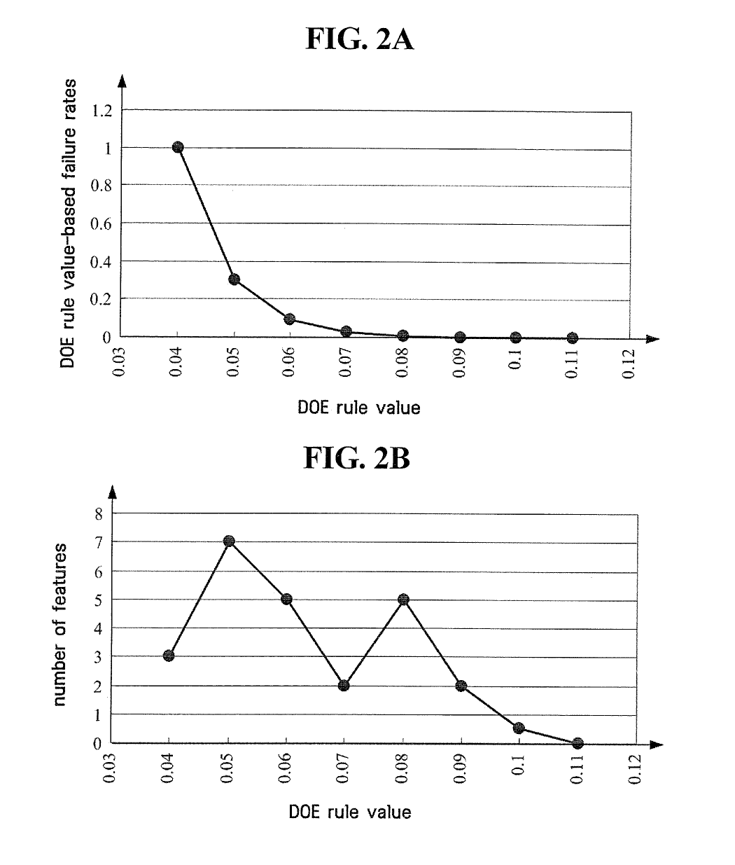

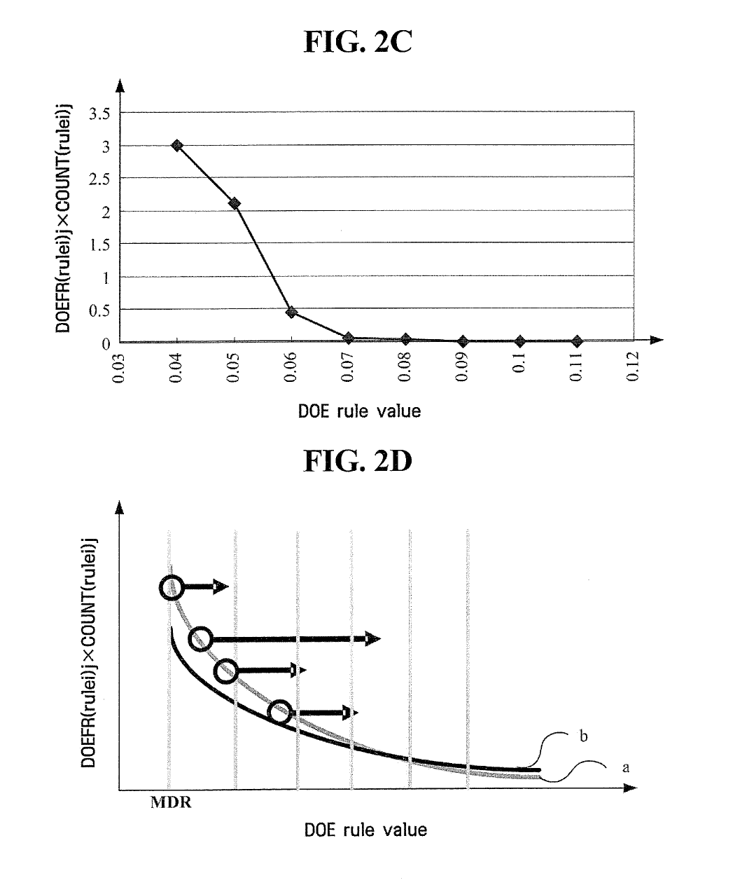

The calculated DOE rule value-based failure rates according to the line spacing example described above are illustrated in FIG. 2A. The x-axis represents the DOE rule values, and the y-axis represents the DOE rule value-based failure rates. As shown in FIG. 2A, when the minimum design rule value is 0.04 μm, the DOE rule value-based failure rate is about 1 ppb (parts per billion), and when the minimum design rule value is 0.05 μm, the DOE rule value-based failure rate is about 0.3 ppb. It can be seen that the DOE rule value-based failure rate is reduced as the DOE rule value increases.

The types of failures that may occur may be different depending on selected design rules. For example, systematic failure may refer to a case in which an integrated circuit device malfunctions when the failure occurs. Examples of systematic failure may include failures occurring in the space between two lines and/or in the minimum enclosure of a line or a via. In these examples, the space between two lines may be too narrow, such that the lines may short, and/or the line or the via may not be connected to a wire. In addition, parametric failure may refer to a case in which a desired magnitude of parameter is not realized in a manufactured integrated circuit device. An example of a parametric failure may include a failure occurring in the minimum width of an active area In this example, as the width of the active area increases, variation in a parameter, such as the saturation current or threshold voltage of a transistor, may consequently vary. Therefore, in the case of a parametric failure, a method of measuring a plurality of DOE rule value-based failure rates may be somewhat different from that in the case of a systematic failure. That is, the parametric failure may be based on the selection of the predetermined target parameter value. For example, when the target parameter value of the saturation current of a transistor is determined to be 1 mA, and the saturation current becomes higher than 1 mA, it can be determined that a failure occurs in a selected design rule (that is, the width of an active area). However, it should be understood that methods of measuring failure rates related to parametric failures according to embodiments of the present invention, are not limited to the above-described method.

Still referring to FIG. 1, the number of features corresponding to each of the DOE rule values within a layout of interest is counted at Block S40. More particularly, in the above example, the number of features corresponding to each of the DOE rule values (i.e., values determined as increasing from 0.04 μm to 0.11 μm in increments of 0.01 μm) within the layout of interest is counted, the results of which are illustrated in FIG. 2B. The x-axis represents the DOE rule values (DOE), and the y-axis represents the numbers of features. For example, as shown in FIG. 2B, the number of features is 3 when the minimum design rule within the layout of interest is 0.04 μm, and the number of features is 7 when the DOE rule value is 0.05 μm.

The fault rates of the selected design rules are provided at Block S50. The fault rates are determined based on the DOE rule value-based failure rates provided at Block S30 and the numbers of features provided at Block S40. More particularly, when an i-th design rule is rulei, the fault rate of the i-th design rule is FaultRate(rulei), the number of a plurality of DOE rule values is n, the failure rate of a j-th DOE rule value for the i-th design rule is DOEFR(rulei)j, and the number of features corresponding to the j-th DOE rule value for the i-th design rule is COUNT(rulei)j, the fault rates of selected design rules can be calculated using the following Equation 1:

$$FaultRate ( rule ⅈ ) = {\sum }_{j = 1}^{n} \{ DOEFR ( rule ⅈ ) j \times COUNT ( rule ⅈ ) j \} \qquad ( 1 )$$

For example, when the selected design rule is the space of two lines, the DOE rule value-based failure rates of FIG. 2A and the numbers of features of FIG. 2B are multiplied with each other, thereby calculating failure values (also referred to herein as DOEFR(rulei)j×COUNT(rulei)j values) as shown in FIG. 2C. Thereafter, the calculated DOEFR(rulei)j×COUNT(rulei)j values are summed, so that the fault rate FaultRate(rulei) of the i-th design rule can be calculated.

In some embodiments of the present invention, the method of acquiring the fault rates of design rules may not be limited to Equation 1. For instance, a method of assigning different weights to the DOE rule value-based failure rates that are of particular interest and the DOE rule value-based failure rates that are not of particular interest may be used. For example, the failure rate of the DOE rule value of 0.04 μm (which may be the minimum design rule value) may have a significant effect on the yield, and may thereby be assigned a weight larger than that of the failure rates of other DOE rule values. That is, when weight wj is assigned to DOEFR(rulei)j, which is the failure rate of the j-th DOE rule value, the following Equation 2 may be applicable:

$$FaultRate ( rule ⅈ ) = {\sum }_{j = 1}^{m} \{ w j \times DOEFR ( rule ⅈ ) j \times COUNT ( rule ⅈ ) j \} \qquad ( 2 )$$

Next, it is determined whether the last yield-critical design rule has been examined at Block S60, and if not, Blocks S20 to S50 (determining DOE rule values, measuring the DOE rule value-based failure rates, counting the number of features corresponding to each of the DOE rule values within the layout of interest, and providing the fault rates of selected design rules) may be repetitively performed for each of the remaining design rules.

The layout of interest is corrected using the fault rates of design rules at Block S70. The largest fault rate may be selected from the plurality of fault rates, and the design rule corresponding to the selected fault rate can be corrected. For example, when the number of yield-critical design rules is five, the operations of Blocks S10 to S60 may be summarized as shown in the following Table 1. In particular, Table 1 illustrates an m×1 matrix (where m is the number of design rules, m≧1), the entries of which are fault rates for layout of interest and design rule pairs. The layout of interest and design rule pairs indicate that the design rules may be selected for predetermined layouts of interest.

TABLE 1

| | Layout of interest |
|---|---|
| rule 1 | 0.8 |
| rule 2 | 0.16 |
| rule 3 | 4.4 |
| rule 4 | 6 |
| rule 5 | 1 |

In Table 1, the largest of the plurality of fault rates is 6, and rule 4, which is the design rule corresponding to the selected fault rate, is corrected. In particular, the largest failure value/DOEFR(rulei)j×COUNT(rulei)j value may be selected from among a plurality of DOEFR(rulei)j×COUNT(rulei)j values included in the fault rate of rule 4, and then a feature corresponding to a DOE rule value corresponding to the selected DOEFR(rulei)j×COUNT(rulei)j can be corrected. For example, if FIG. 2C illustrates the DOEFR(rulei)j×COUNT(rulei)j values of rule 4, the DOEFR(rulei)j×COUNT(rulei)j value for the DOE rule value of 0.04 μm is the largest at about 3 ppb, and then the design rule for the DOE rule value of 0.04 μm within the layout of interest is corrected.

When the layout of interest is corrected, all design rules of which the DOE rule values are 0.04 μm may also be corrected. However, when the design rule value of 0.04 μm is corrected to be greater than 0.04 μm (for example, 0.05 μm or 0.06 μm), the area of the layout of interest may increase. Therefore, only design rules that can be corrected within the range in which the overall area of the layout of interest does not increase may be corrected according to some embodiments of the present invention. When the correction is performed in the above-mentioned example, DOEFR(rulei)j×COUNT(rulei)j values according to the above DOE rule values are illustrated as in FIG. 2D. As shown in FIG. 2D, reference character “a” represents the state before correction, and reference character “b” represents the state after correction. It can be seen that the DOEFR(rulei)j×COUNT(rulei)j value corresponding to a minimum design rule (MDR) value of 0.04 μm dramatically decreases after correction.

Although a case in which a largest fault rate is selected from among a plurality of fault rates is described above with reference to FIGS. 1 and 2A-2D for correcting the layout of interest using the fault rates of design rules, other correction methods according to some embodiments of the present invention may be used. For example, the fault rates may be arranged in descending order, and the plurality of design rules corresponding to the fault rates can be corrected according to the arrangement order of the fault rates. That is, in Table 1, rule 4 may be corrected first, and then correction can be performed in the order of rule 3 and rule 5.

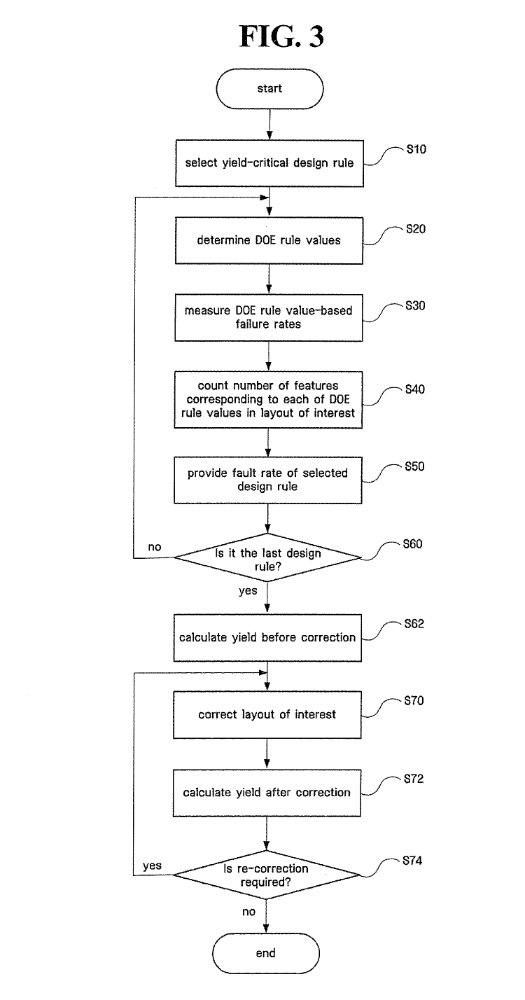

FIG. 3 is a flowchart illustrating operations for enhancing the yield of integrated circuit devices according to other embodiments of the present invention. The same reference numerals are used for blocks that are substantially the same as those illustrated in FIG. 1, and thus detailed descriptions thereof are omitted.

Referring now to FIG. 3, in methods of enhancing the yield of integrated circuit devices according to other embodiments of the present invention, the yield is calculated at Blocks S62 and S72 both before and after the correction (Block S70) of a layout of interest. In particular, the yield of the layout of interest is calculated using the fault rates of a plurality of design rules before the correction (Block S70) of the layout of interest at Block S62.

A method of calculating the yield based on a poisson model using Equations 3 to 5 is described below. When the total fault rate of the layout of interest is TotalFaultRate, and the number of selected design rules is m, the total fault rate can be calculated by summing the fault rates (FaultRate(rulei)) of the plurality of design rules that were calculated using Equation 1, as provided by Equation 3:

$$TotalFault Rate = {\sum }_{i = 1}^{m} FaultRate ( rule ⅈ ) \qquad ( 3 )$$

However, methods of providing the total fault rate of the layout of interest according to embodiments of the present invention are not limited to Equation 3. For example, a method of assigning different weights to the fault rates of rules based on the degree of interest can be used. That is, when weight Wi is assigned to the FaultRate(rulei) of the i-th rule, the total fault rate can be calculated as provided by Equation 4:

$$TotalFault Rate = {\sum }_{i = 1}^{m} W ⅈ \times FaultRate ( rule ⅈ ) \qquad ( 4 )$$

The yield is calculated using the calculated total fault rate of the layout of interest. The yield of the layout of interest is calculated as provided by Equation 5, where C_{Yield}(0≦C_{Yield}≦1) is a yield constant which represents variation in the yield occurring for reasons other than the above-described variation in yield due to the design rule:
Yield=C_{Yield}×exp(−TotalFault rate) (5)

In addition, a method of calculating yield based on a negative binomial model is described as follows using Equations 6 and 7. In this case, αⁱ is a processing constant, and C_{Yield}(0≦C_{Yield}≦1) is a yield constant which represents variation in the yield occurring for reasons other than the above-described variation in yield due to the design rule. Equation 6 represents the case in which the yield is calculated without weight, and Equation 7 represents the case in which the yield is calculated using weight Wi:

$$\begin{matrix}Yield = {C}_{Yield} \times {\prod }_{i = 1}^{m} ( 1 + \frac{FaultRate ( rule ⅈ )}{{α}^{i}} ) {α}^{i} & ( 6 ) \\ Yield = {C}_{Yield} \times {\prod }_{i = 1}^{m} ( 1 + \frac{W ⅈ \times FaultRate ( rule ⅈ )}{{α}^{i}} ) {α}^{i} & ( 7 )\end{matrix}$$

However, it is to be understood that while calculating the yield of integrated circuit devices according to the some embodiments of the present invention are illustrated using the poisson model and the negative binomial model, embodiments of the present invention are not limited to such models, and one of ordinary skill in the art will appreciate that the yield can be calculated using other models.

After the correction (Block S70) of the layout of interest, the yield of the layout of interest is calculated using the fault rates of the plurality of design rules at Block S72. That is, counting the number of features corresponding to each of the DOE rule values within the corrected layout of interest, and providing the fault rates of the design rules using the DOE rule value-based failure rates and the number of features are repetitively performed for a plurality of yield-critical design rules. The corrected yield of the layout of interest is calculated using the fault rates of the plurality of design rules.

The yield before the correction is compared with the yield after the correction, and whether the corrected layout of interest is to be re-corrected is determined at Block S74. For example, when the yield after the correction does not increase by 5% or more compared to the yield before the correction, the layout of interest may be re-corrected by returning to Block S70.

In addition, although not shown in the drawings, a corrected layout of interest can be re-corrected until the yield after the correction is above a predetermined target yield in some embodiments. In this case, the yield before the correction may not be calculated at Block S62, and the yield after the correction may be calculated at Block S72 as described above.

Furthermore, although described above with reference to comparisons of the yields before and after the correction of the layout of interest and with reference to comparisons of the yield after the correction of the layout of interest with a predetermined target yield, embodiments of the present invention are not limited to yield-based comparisons. For example, because the yield is proportional to the total fault rate (as shown in Equations 5, 6, and 7), the total fault rates before and after the correction of the layout of interest may be compared with each other, or the total fault rate after the correction of the layout of interest may be compared with a target total fault rate.

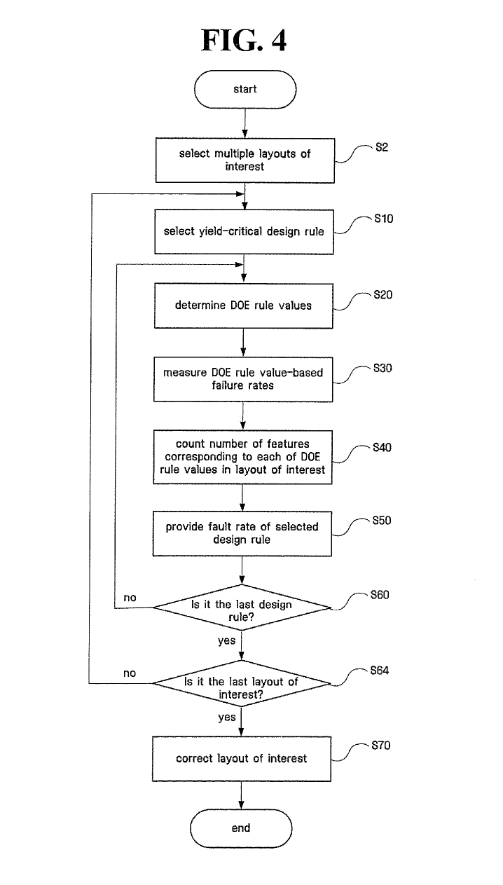

FIG. 4 is a flowchart illustrating operations for enhancing the yield of integrated circuit devices according to further embodiments of the present invention. The same reference numerals are used for blocks that are substantially the same as in FIG. 1, and as such, detailed descriptions thereof are omitted.

Referring now to FIG. 4, in methods of enhancing the yield of integrated circuit devices according to further embodiments of the present invention, the priorities of a plurality of layouts of interest are determined, and then a selected layout of interest is corrected. More particularly, a plurality of layouts of interest (for example, l layouts, where l≧2) is selected at Block S2. For example, the layout of interest may be the layout of a cell selected among a standard cell library. The standard cell library may be a library of layouts of frequently used circuits provided for convenience of design when the layout of a integrated circuit device is designed. For example, the standard cell library may include layouts for an inverter, a NAND gate, a flip-flop, or the like.

Thereafter, the selection (Block S10) of a yield-critical design rule, the determination (Block S20) of a plurality of DOE rule values for a selected design rule, the measurement (Block S30) of a plurality of DOE rule value-based failure rates, the counting (Block S40) of the number of features corresponding to each of the DOE rule values within the layout of interest, the providing (Block S50) of the fault rates of the selected design rule using the DOE rule value-based failure rates and the number of features, and the determination (Block S60) of whether Blocks S20 to S50 have been performed for all of the selected design rules are repeatedly performed for each of the selected layouts of interest at Block S64.

The layout of interest is corrected using the fault rate of the design rule at Block S70. In some embodiments, the largest one of the plurality of fault rates may be selected, and the layout of interest related to the selected fault rate may be corrected, such that the design rule corresponding to the selected fault rate within the layout of interest may be corrected. For example, when the number of selected layouts of interest is six, and the number of yield-critical design rules is five, Blocks S2 to S64 may be summarized as shown in Table 2. In particular, Table 2 illustrates an m×l matrix (where m is the number of design rules, and l is the number of layouts of interest, m≧2 and l≧1), the entries of which are fault rates for layout of interest and design rule pairs.

TABLE 2

| | cell 1 | cell 2 | cell 3 | cell 4 | cell 5 | cell 6 |
|---|---|---|---|---|---|---|
| rule 1 | 20 | 200 | 240 | 0 | 20 | 400 |
| rule 2 | 0 | 40 | 40 | 0 | 0 | 0 |
| rule 3 | 250 | 1100 | 300 | 0 | 0 | 0 |
| rule 4 | 350 | 1500 | 1400 | 250 | 260 | 1300 |
| rule 5 | 0 | 250 | 400 | 0 | 0 | 220 |

In Table 2, the fourth rule (rule 4) of a second layout (cell 2) of interest has the largest fault rate of 1500. Therefore, (cell2, rule 4) may be corrected. Here, (cell 2, rule 4) means the fourth rule (rule 4) of the second layout (cell 2). In the above method of correction, the largest DOEFR(rulei)j×COUNT(rulei)j value is selected from among a plurality of DOEFR(rulei)j×COUNT(rulei)j values included in the fault rates of (cell 2, rule 4), and the design rule corresponding to the selected DOEFR(rulei)j×COUNT(rulei)j value can be corrected as described with reference to FIG. 1.

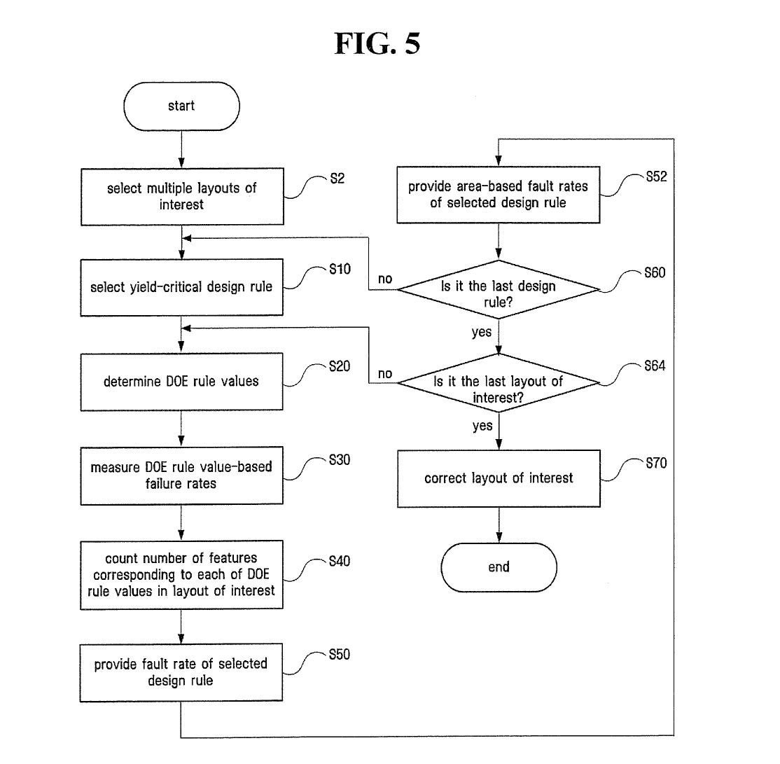

FIG. 5 is a flowchart illustrating operations for enhancing the yield of integrated circuit devices according to still further embodiments of the present invention. The same reference numerals are used for blocks that are substantially the same as in FIG. 1, and thus detailed descriptions thereof are omitted.

Referring now to FIG. 5 the methods of enhancing the yield of integrated circuit devices according to still further embodiments include dividing the calculated fault rates of a design rule by the areas of the layouts of interest related to the fault rates of the design rule, and then calculating area-based fault rates at Block S52. Although, the area-based fault rates are calculated immediately after the calculation of the fault rates of the selected design rule in FIG. 5, embodiments of the present invention are not limited to such calculations. That is, the area-based fault rates may be calculated at any time as long as the fault rate of the selected design rule is calculated before the layout is corrected.

The correction of the layout of interest at Block S70 is based on providing the total area-based fault rates of the layouts of interest using the plurality of area-based fault rates, and the selection of the layout of interest to be corrected using the total area-based fault rates of the plurality of layouts of interest. The fault rates of Table 2 are divided by the areas of the respective layouts of interest and the area-based fault rates are calculated as shown in the following Table 3.

TABLE 3

| | | | | | |
|---|---|---|---|---|---|
| cell 1 | cell 2 | cell 3 | cell 4 | cell 5 | cell 6 |

area

| | 50 | 250 | 200 | 25 | 80 | 500 |
|---|---|---|---|---|---|---|
| rule 1 | 0.4 | 0.8 | 1.2 | 0 | 0.25 | 0.8 |
| rule 2 | 0 | 0.16 | 0.2 | 0 | 0 | 0 |
| rule 3 | 5 | 4.4 | 1.5 | 0 | 0 | 0 |
| rule 4 | 7 | 6 | 7 | 10 | 3.25 | 2.6 |
| rule 5 | 0 | 1 | 2 | 0 | 0 | 0.44 |

In Table 3, the fourth rule (rule 4) of the first layout (cell 1) of interest and the fourth rule (rule 4) of the third layout (cell 3) of interest have the largest area-based fault rate of 7. Therefore, (cell 1, rule 4) and (cell 3, rule 4) may be corrected.

A reason for calculating area-based fault rates is that the areas of the respective layouts of interest may be different, and the possibility of having a larger fault rate may be higher as the area of the layout of interest increases. For example, as shown in Table 3, the first layout of interest may have a lower fault rate simply because it is smaller than the second, third and sixth layouts of interest; however, the area-based fault rate of the first layout of interest is relatively large (see (cell 1, rule 3) and (cell 1, rule 4)).

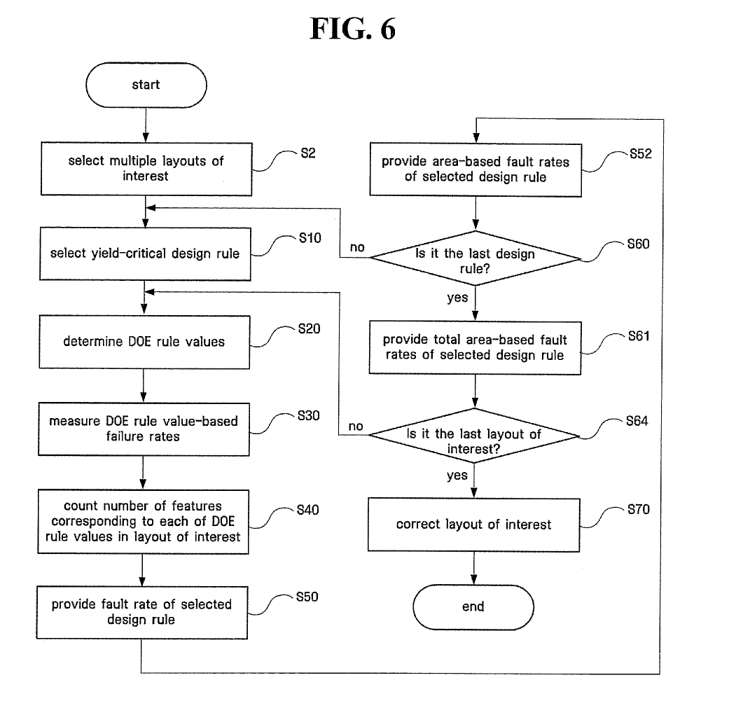

FIG. 6 is a flowchart illustrating operations for enhancing the yield of integrated circuit devices according to still further embodiments of the present invention. The same reference numerals are used for blocks that are substantially the same as in FIG. 5, and as such, detailed descriptions thereof are omitted.

Referring now to FIG. 6, methods of enhancing the yield of integrated circuit devices according to still further embodiments include providing the total area-based fault rates of the layouts of interest using the calculated area-based fault rates at Block S61. Providing the total area-based fault rates may be performed at any time, as long as the area-based fault rates of the selected design rule are calculated before the layout is corrected.

The correction (Block S70) of the layout of interest may include selecting the largest total area-based fault rate from among the plurality of total area-based fault rates, and correcting the layout of interest related to the selected total area-based fault rate. The total area-based fault rates are calculated using the area-based fault rates of Table 3, as shown in Table 4. The calculation of the total area-based fault rates may be performed by summing the plurality of area-based fault rates for each of the layouts of interest, but embodiments of the present invention are not limited to such a calculation.

TABLE 4

| | cell 1 | cell 2 | cell 3 | cell 4 | cell 5 | cell 6 |
|---|---|---|---|---|---|---|
| rule 1 | 0.4 | 0.8 | 1.2 | 0 | 0.25 | 0.8 |
| rule 2 | 0 | 0.16 | 0.2 | 0 | 0 | 0 |
| rule 3 | 5 | 4.4 | 1.5 | 0 | 0 | 0 |
| rule 4 | 7 | 6 | 7 | 10 | 3.25 | 2.6 |
| rule 5 | 0 | 1 | 2 | 0 | 0 | 0.44 |
| total | 12.4 | 11.36 | 11.9 | 10 | 3.5 | 3.84 |

In Table 4, the first layout (cell 1) of interest has the largest total area-based fault rate of 12.4. Therefore, the first layout of interest may be corrected. In some embodiments, the correction method may be that suggested in the embodiments of the present invention as described above with reference to FIG. 1.

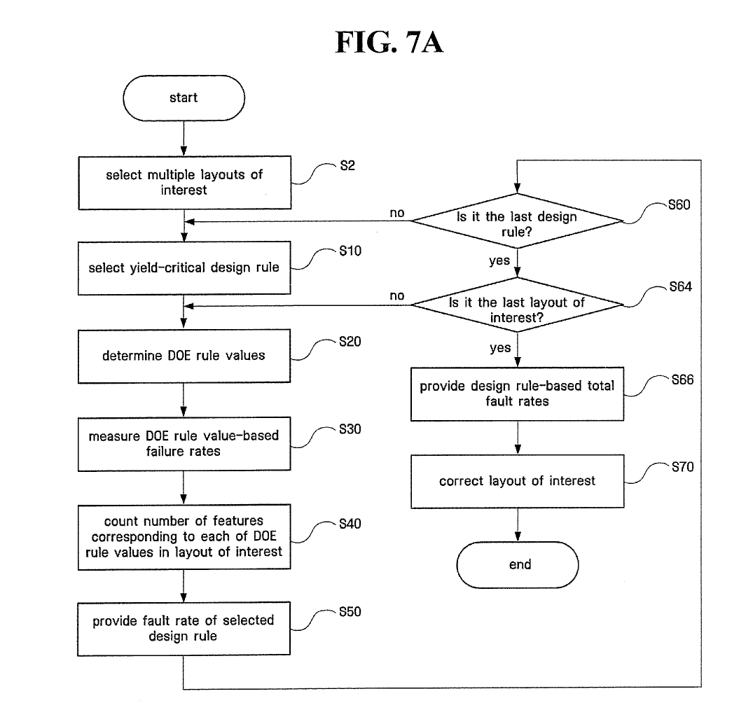

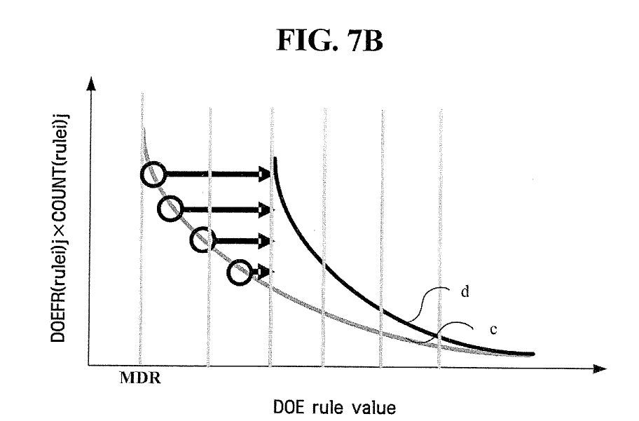

FIG. 7A is a flowchart illustrating operations for enhancing the yield of integrated circuit devices according to yet further embodiments of the present invention. The same reference numerals are used for blocks that are substantially the same as shown in FIG. 3, and thus, detailed descriptions thereof are omitted.

Referring now to FIG. 7A, methods of enhancing the yield of integrated circuit devices according to yet further embodiments include calculating the design rule-based total fault rates using the calculated fault rates of the design rules at Block S66. For example, the largest one from among the plurality of design rule-based fault rates may be selected, and then a plurality of design rules related to the selected design rule-based total fault rate may be corrected.

The design rule-based total fault rates may be calculated using the fault rates of Table 2 as shown in Table 5. The calculation of the design rule-based total fault rates may be performed by simply summing a plurality of fault rates for each of the design rules, but embodiments of the present invention are not limited to such a calculation.

TABLE 5

| | cell 1 | cell 2 | cell 3 | cell 4 | cell 5 | cell 6 | total |
|---|---|---|---|---|---|---|---|
| rule 1 | 20 | 200 | 240 | 0 | 20 | 400 | 880 |
| rule 2 | 0 | 40 | 40 | 0 | 0 | 0 | 80 |
| rule 3 | 250 | 1100 | 300 | 0 | 0 | 0 | 1650 |
| rule 4 | 350 | 1500 | 1400 | 250 | 260 | 1300 | 5060 |
| rule 5 | 0 | 250 | 400 | 0 | 0 | 220 | 870 |

In Table 5, the fourth rule (rule 4) has the largest design rule-based total fault rate of 5060. Therefore, the fourth design rules of all of the layouts of interest may be corrected. For example, the fourth design rules of the layouts of interest may be arranged in descending order, and the correction may be performed in the order of size of the arranged design rules. For example, as shown in Table 5, the correction may be performed in the order of cell 2, cell 3, cell 6, cell 1, cell 5, and cell 4.

When the layouts of interest are corrected using the above-described method, the DOEFR(rulei)j×COUNT(rulei)j values for DOE rule values are shifted by a predetermined distance as shown in FIG. 7B. In this case, reference character “c” indicates the state before the correction, and reference character “d” indicates the state after the correction. For example, since a minimum design rule value is changed from 0.04 μm to a higher value (for example, 0.06 μm), the shift in the graph is generated.

Although not shown in the drawings, one or more masks may be manufactured for use with any of the methods of estimating the yield of integrated circuit devices described above with reference to FIGS. 1 to 7B. Accordingly, such mask(s) may be included within the scope of the present invention. Furthermore, an integrated circuit device manufactured using such mask(s) may also be included within the scope of the present invention.

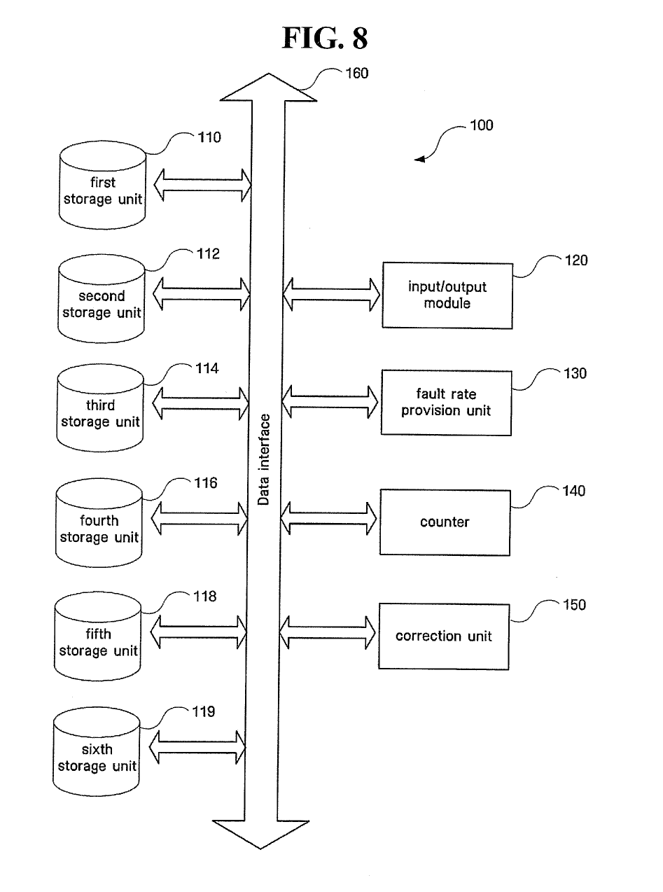

FIG. 8 is a block diagram illustrating a system for enhancing the yield of integrated circuit devices according to some embodiments of the present invention.

Referring now to FIG. 8, the system 100 for enhancing the yield of integrated circuit devices according to some embodiments of the present invention includes first to sixth storage units 110, 112, 114, 116, 118 and 120, an input/output module 120, a fault rate provision unit 130, a counter 140, and a correction unit 150. As used herein, a “unit” may refer to an apparatus and/or device configured to execute instructions according to some embodiments of the present invention. The respective units can communicate with each other via a data interface 160 and/or other communication links.

The first storage unit 110 stores a plurality of DOE rule values for design rules. The second storage unit 112 stores DOE rule value-based failure rates. The third storage unit 114 stores layouts of interest, and the fourth storage unit 116 stores yield-critical design rules. The plurality of DOE rule values stored in the first storage unit 110 may be values acquired at increments of a predetermined interval from the minimum design rule of a design rule stored in the fourth storage unit 116. The predetermined interval may be based on a design grid and/or a multiple thereof.

The data stored in the first to fourth storage units 110, 112, 114 and 116 may be values directly stored from the input/output module 120, and/or may be values calculated using a separate calculation unit (not shown). For example, the DOE rule value-based failure rates stored in the second storage unit 112 may be values calculated by forming a test pattern respectively representing a selected design rule on a wafer for each of the plurality DOE rule values, and then counting the test patterns in which failure (for example, systematic or parametric failure) occurs for each of the DOE rule values. Also, the plurality of DOE rule values stored in the first storage unit 110 may be values directly input through the input/output module 120, and/or may be values from a separate calculation unit that automatically calculates and causes the DOE rule values to be stored based on the design rules stored in the fourth storage unit 116.

The counter 140 receives the plurality of DOE rule values and the layout of interest from the first storage unit 110 and the third storage unit 114, respectively, counts the number of features corresponding to each of the DOE rule values within the layout of interest, and stores the result in the fifth storage unit 118.

The fault rate provision unit 130 calculates the fault rates of design rules using the DOE rule value-based failure rates provided from the second storage unit 112 and the numbers of features provided from the fifth storage unit 118, and then stores the result in the sixth storage unit 119.

The correction unit 150 suggests design rules for the layout of interest to be corrected based on the fault rates of the design rules provided from the sixth storage unit 119.

Accordingly, in methods of enhancing the yield of integrated circuit devices according to various embodiments of the present invention as described above with reference to FIG. 1, the plurality of DOE rule values of a plurality of design rules may be stored in the first storage unit 110. The second storage unit 112 may store a DOE rule value-based failure rates. Therefore, the fault rate provision unit 130 may provide an m×1 matrix (where m is the number of design rules, and m≧1), the entries of which are fault rates for layout of interest and design rule pairs. The respective fault rates may be calculated using Equations 1 and 2. The correction unit 150 may select the largest fault rate from among the calculated plurality of fault rates and suggest a design rule corresponding to the selected fault rate, and/or may arrange the plurality of fault rates in descending order and suggest a design rule corresponding to a fault rate according to the order of arrangement of the fault rates.

In addition, in some embodiments, the system 100 for enhancing the yield of integrated circuit devices may further include a yield calculation unit (not shown) for calculating the yield of a layout of interest. Accordingly, in methods of enhancing the yield of integrated circuit devices according to embodiments of the present invention as described above with reference to FIG. 3, the yield calculation unit may calculate yields using Equations 3 to 5 (or Equations 6 and 7) before and after the correction of the layout of interest. The correction unit 150 may compare the yield before the correction with the yield afterwards to determine whether re-correction is required. Also, the yield calculation unit may calculate the yield after the correction of the layout of interest, and the correction unit may compare the yield after the correction with a predetermined target yield to determine whether re-correction is required.

Also, in methods of enhancing the yield of integrated circuit devices according to embodiments of the present invention discussed above with reference to FIG. 4, the first storage unit 110 may store a plurality of DOE rule values for each of a plurality of layout of interest and design rules pairs (i.e., multiple layouts of interest may be present). As a result, the fault rate provision unit 130 may provide a m×l matrix (where m is the number of design rules, l is the number of layouts of interest, and m≧1 and l≧1), the entries of which are fault rates for layout of interest and design rule pairs. The correction unit 150 may select the largest fault rate of the calculated plurality of fault rates and propose a design rule related to the selected fault rate, and/or may arrange the plurality of fault rates in descending order and suggest a design rule corresponding to the fault rate selected within the layout of interest.

Also, in some embodiments, the system for enhancing the yield of integrated circuit devices may further include an area-based fault rate calculation unit (not shown) for dividing a plurality of fault rates by corresponding areas of layouts of interest to thereby calculate area-based fault rates. Accordingly, in methods of enhancing the yield of the integrated circuit devices according to embodiments of the present invention as discussed above with reference to FIG. 5, the area-based fault rate calculation unit may provide an m×l matrix (where m is the number of design rules, l is the number of layouts of interest, and m≧1 and l≧1), the entries of which are area-based fault rates for layout of interest and design rule pairs. The correction unit 150 may select the largest from among the area-based fault rates, may select a layout of interest related to the selected area-based fault rate, and may suggest a design rule corresponding to the selected area-based fault rate in the layout of interest.

In addition, in methods of enhancing the yield of integrated circuit devices according to embodiments of the present invention as described above with reference to FIG. 6, the area-based fault rate calculation unit (not shown) may further provide the total area-based fault rates of layouts of interest using the plurality of area-based fault rates. The correction unit 150 may suggest a layout of interest to be corrected based on the total area-based fault rates of layouts of interest. For example, the correction unit 150 may select the largest from among the total area-based fault rates, and may suggest a layout of interest related to the selected total area-based fault rate.

Furthermore, in methods of enhancing the yield of integrated circuit devices according to embodiments of the present invention as described above with reference to FIG. 7A, the fault rate calculation unit (not shown) may further calculate design rule-based total fault rates using a plurality of fault rates. The correction unit 150 may select the largest from among the design rule-based total fault rates, and may suggest a design rule related to the selected design rule-based total fault rate.

As described above, according to some embodiments of the present invention for enhancing the yield of integrated circuit devices, it may be possible to design a layout having an improved yield by correcting the layout of interest using previously calculated fault rates of design rules. It is to be understood that, in some embodiments, the operations described above with reference to FIGS. 1-8 may be programmatically performed, i.e., by a computer and/or other instruction-executing apparatus.

In the drawings and specification, there have been disclosed exemplary embodiments of the invention, and although specific terms are used, they are used in a generic and descriptive sense only and not for purposes of limitation, the scope of the invention being defined by the following claims.

That which is claimed:

1. A method of improving yield in integrated circuit device fabrication, the method comprising:
calculating a fault rate for a design rule based on a plurality failure rates for a corresponding plurality of Design Of Experiment (DOE) rule values and based on numbers of features in a layout of interest corresponding to ones of the plurality of DOE rule values; and
correcting the layout of interest based on the fault rate for the design rule.

2. The method of claim 1, wherein calculating the fault rate comprises:
programmatically calculating the fault rate for the design rule.

3. The method of claim 1, further comprising:
determining the plurality of DOE rule values for the design rule;
measuring the plurality of failure rates for the corresponding plurality of DOE rule values to provide a plurality of DOE rule value-based failure rates; and
counting the numbers of features in the layout of interest corresponding to ones of the plurality of DOE rule values,
wherein calculating the fault rate comprises providing the fault rate of the design rule using the DOE rule value-based failure rates and the numbers of features.

4. The method of claim 3, wherein the design rule comprises a yield-critical design rule among a plurality of design rules for the layout of interest.

5. The method of claim 3, wherein determining the plurality of DOE rule values comprises:
assigning the plurality of DOE rule values at increments of a predetermined interval from a minimum design rule value.

6. The method of claim 5, wherein the predetermined interval is based on a design grid and/or a multiple of the design grid.

7. The method of claim 3, wherein measuring the plurality of failure rates comprises:
forming test patterns representing the design rule on a wafer for each of the plurality of DOE rule values; and
determining a number of test patterns in which a failure occurs for each of the plurality of DOE rule values.

8. The method of claim 7, wherein the failure comprises a systematic and/or parametric failure.

9. The method of claim 3, wherein, before correcting the layout of interest, determining the DOE rule values, measuring the failure rates, counting the numbers of features, and providing the fault rate are repeatedly performed for a plurality of design rules to provide a plurality of fault rates corresponding to the plurality of design rules.

10. The method of claim 9, further comprising the following prior to correcting of the layout of interest:
providing the plurality of fault rates for the layout of interest in an m×1 matrix,
wherein the plurality of design rules comprises m design rules, and wherein m≧1.

11. The method of claim 1, wherein calculating the fault rate for the design rule comprises:
for each of the plurality of DOE rule values, multiplying the failure rate for a respective DOE rule value by the number of features corresponding to the respective DOE rule value to provide a plurality of failure values; and
adding the plurality of failure values to provide the fault rate for the design rule.

12. The method of claim 1, wherein the calculating the fault rate of the design rule comprises:
calculating the fault rate using an equation represented by
$$FaultRate ( rule ⅈ ) = {\sum }_{j = 1}^{n} \{ DOEFR ( rule ⅈ ) j \times COUNT ( rule ⅈ ) j \} ,$$
wherein rulei is an i-th design rule, wherein FaultRate(rulei) is a fault rate of the i-th design rule, wherein n is a number of DOE rule values, wherein DOEFR(rulei)j is a failure rate of a j-th DOE rule value for the i-th design rule, and wherein COUNT(rulei)j is a number of features corresponding to the j-th DOE rule value for the i-th design rule.

13. The method of claim 9, wherein the correcting the layout of interest comprises:
selecting a largest fault rate among the plurality of fault rates; and
correcting one of the plurality of design rules corresponding to the selected fault rate.

14. The method of claim 9, wherein the correcting the layout of interest comprises:
arranging the plurality of fault rates in a predetermined order; and
correcting one of the plurality of design rules corresponding to one of the plurality of fault rates based on the predetermined order.

15. The method of claim 1, further comprising:
calculating a yield of the layout of interest before correcting the layout of interest.

16. The method of claim 15, wherein the calculating the yield before correcting the layout of interest comprises:
calculating the yield using an equation represented by
Yield=C_{Yield}×exp(−TotalFault rate),
wherein C_{Yield} is a yield constant wherein 0≦C_{Yield}≦1, wherein TotalFaultRate is a total fault rate of the layout of interest and wherein
$$TotalFault Rate = {\sum }_{i = 1}^{m} FaultRate ( rule ⅈ ) ,$$
wherein rulei is an i-th design rule, wherein FaultRate(rulei) is a fault rate of the i-th design rule, and wherein m is a number of selected design rules.

17. The method of claim 15, wherein the calculating the yield before correcting the layout of interest comprises:
calculating the yield using an equation represented by
$$Yield = {C}_{Yield} \times {\prod }_{i = 1}^{m} ( 1 + \frac{FaultRate ( rule ⅈ )}{{α}^{i}} ) {α}^{i} ,$$
wherein rulei is an i-th design rule, wherein FaultRate(rulei) is a fault rate of the i-th design rule, wherein m is a number of selected design rules, wherein αⁱ is a processing constant, and wherein C_{Yield} is a yield constant wherein 0≦C_{Yield}≦1.

18. The method of claim 15, further comprising:
calculating a yield of the layout of interest after correcting of the layout of interest; and
determining whether to re-correct the layout of interest by comparing the yield calculated after the correction with the yield calculated before the correction.

19. The method of claim 1, further comprising:
calculating a yield of the layout of interest after the correcting the layout of interest; and
determining whether to re-correct the layout by comparing the yield calculated after the correction with a predetermined target yield.

20. The method of claim 1, further comprising:
determining a plurality of layouts of interest;
determining a plurality of design rules associated with ones of the plurality of layouts of interest; and
calculating a plurality of fault rates for the plurality of design rules.

21. The method of claim 20, further comprising the following prior to correcting of the layout of interest:
providing the plurality of fault rates in an m×l matrix,
wherein the plurality of design rules comprise m design rules, wherein the plurality of layouts of interest comprise l layouts of interest, wherein m≧2, and wherein l≧2.

22. The method of claim 20, wherein the plurality of layouts of interest comprise a plurality of cell layouts selected from a standard cell library.

23. The method of claim 20, wherein the correcting the layout of interest comprises:
selecting a largest fault rate among the plurality of fault rates; and
correcting one of the plurality of layouts of interest corresponding to the selected fault rate.

24. The method of claim 20, further comprising the following prior to correcting of the layout of interest:
dividing the plurality of fault rates by corresponding ones of a plurality of areas respectively corresponding to the plurality of layouts of interest to calculate a plurality of area-based fault rates.

25. The method of claim 24, wherein the correcting the layout of interest comprises:
determining a plurality of total area-based fault rates corresponding to the plurality of layouts of interest based on the plurality of area-based fault rates; and
selecting one of the plurality of layouts of interest to be corrected based on the plurality of total area-based fault rates.

26. The method of claim 25, wherein selecting one of the plurality of layouts of interest to be corrected using the plurality of total area-based fault rates comprises:
selecting a largest total area-based fault rate among the plurality of total area-based fault rates; and
correcting one of the plurality of layouts of interest corresponding to the selected total area-based fault rate.

27. The method of claim 20, further comprising the following prior to correcting of the layout of interest:
calculating a plurality of design rule-based total fault rates using the plurality of fault rates.

28. The method of claim 27, further comprising:
selecting a largest design rule-based total fault rate among the plurality of design rule-based total fault rates; and
correcting one of the plurality of layouts of interest associated with one of the plurality of design rules corresponding to the selected design rule-based total fault rate.

29. A computer program product for improving yield in integrated circuit device fabrication, the computer program product comprising:
a computer readable storage medium including computer readable program code therein, the computer readable program code configured to carry out the method of claim 1.

30. A mask manufactured for use in correcting the layout of interest according to the method of claim 1.

31. An integrated circuit device manufactured using the method of claim 1.

32. A system for improving yield in integrated circuit device fabrication, comprising:
a fault rate provision unit configured to calculate a fault rate for a design rule based on a plurality failure rates for a corresponding plurality of Design Of Experiment (DOE) rule values and based on numbers of features in a layout of interest corresponding to ones of the plurality of DOE rule values; and
a correction unit configured to suggest correction for the layout of interest based on the fault rate for the design rule.

33. The system of claim 32, further comprising:
a first storage unit configured to store the plurality of DOE rule values for the design rule;
a second storage unit configured to store the plurality of failure rates for the corresponding plurality of DOE rule values as a plurality of DOE rule value-based failure rates; and
a counter configured to count the numbers of features in the layout of interest corresponding to ones of the plurality of DOE rule values;
wherein the fault rate provision unit is configured to provide the fault rate of the design rule using the plurality of DOE rule value-based failure rates and the numbers of features.

34. The system of claim 33, wherein the design rule comprises a yield-critical design rule among a plurality of design rules for the layout of interest.

35. The system of claim 33, wherein the plurality of DOE rule values are assigned at increments of a predetermined interval from a minimum design rule value.

36. The system of claim 35, wherein the predetermined interval is based on a design grid and/or a multiple of the design grid.

37. The system of claim 33, further comprising:
test patterns representing the design rule for each of the plurality of DOE rule values on a wafer,
wherein the plurality of DOE rule value-based failure rates are calculated based on a number of the test patterns in which a failure occurs for each of the plurality of DOE rule values.

38. The system of claim 37, wherein the failure comprises a systematic and/or parametric failure.

39. The system of claim 33, wherein the first storage unit is configured to store a plurality of DOE rule values for a plurality of design rules, and wherein the fault rate provision unit is configured to calculate a plurality of fault rates for the plurality of design rules.

40. The system of claim 39, wherein the fault rate provision unit is configured to provide the plurality of fault rates for the layout of interest in an m×1 matrix, wherein the plurality of design rules comprises m design rules, and wherein m≧1).

41. The system of claim 32, wherein the fault rate provision unit is configured to multiply the failure rate for a respective DOE rule value by the number of features corresponding to the respective DOE rule value for each of the plurality of DOE rule values to provide a plurality of failure values, and is further configured to add the plurality of failure values to provide the fault rate for the design rule.

42. The system of claim 32, wherein the fault rate provision unit is configured to calculate the fault rate of the design rule using an equation represented by
$$FaultRate ( rule ⅈ ) = {\sum }_{j = 1}^{n} \{ DOEFR ( rule ⅈ ) j \times COUNT ( rule ⅈ ) j \} ,$$
wherein rulei is an i-th design rule, wherein FaultRate(rulei) is a fault rate of the i-th design rule, wherein n is a number of DOE rule values, wherein DOEFR(rulei)j is a failure rate of a j-th DOE rule value for the i-th design rule, and wherein COUNT(rulei)j is a number of features corresponding to the j-th DOE rule value for the i-th design rule.

43. The system of claim 39, wherein the correction unit is configured to select a largest fault rate among the plurality of fault rates and suggest correction for one of the plurality of design rules corresponding to the selected fault rate.

44. The system of claim 39, wherein the correction unit is configured to arrange the plurality of fault rates in a predetermined order and suggest correction for one of the plurality of design rules corresponding to one of the plurality of fault rates based on the predetermined order.

45. The system of claim 35, further comprising:
a yield calculation unit configured to calculate a yield of the layout of interest.

46. The system of claim 45, wherein the yield calculation unit is configured to calculate the yield using an equation represented by
$$\begin{matrix}Yield = {C}_{Yield} \times exp ( - TotalFault Rate ) \\ = {C}_{Yield} \times exp ( - {\sum }_{i = 1}^{m} FaultRate ( rule ⅈ ) ) ,\end{matrix}$$
wherein C_{Yield} is a yield constant wherein 0≦C_{Yield}≦1, wherein TotalFaultRate is a total fault rate of the layout of interest and wherein
$$TotalFault Rate = {\sum }_{i = 1}^{m} FaultRate ( rule ⅈ ) ,$$
wherein rulei is an i-th design rule, wherein FaultRate(rulei) is a fault rate of the i-th design rule, and wherein m is a number of selected design rules.

47. The system of claim 45, wherein the yield calculation unit is configured to calculate the yield using an equation represented by
$$Yield = {C}_{Yield} \times {\prod }_{i = 1}^{m} ( 1 + \frac{FaultRate ( rule ⅈ )}{{α}^{i}} ) {α}^{i}$$
wherein rulei is an i-th design rule, wherein FaultRate(rulei) is a fault rate of the i-th design rule, wherein m is a number of selected design rules, wherein αⁱ is a processing constant, and wherein C_{Yield} is a yield constant wherein 0≦C_{Yield}≦1.

48. The system of claim 45, wherein the yield calculation unit is configured to calculate the yield before and after the correction unit is configured to suggest correction for the layout of interest, and wherein the correction unit is configured to determine whether to perform re-correction based on a comparison of the yield after the correction with the yield before the correction.

49. The system of claim 45, wherein the yield calculation unit is configured to calculate the yield after the correction unit is configured to suggest correction for the layout of interest, and wherein the correction unit is configured to determine whether to perform re-correction based on a comparison of the yield after the correction with a predetermined target yield.

50. The system of claim 33, wherein the layout of interest comprises one of a plurality of layouts of interest, wherein ones of the plurality of layouts of interest are associated with ones of a plurality of design rules, wherein the first storage unit is configured to store a plurality of DOE rule values for the plurality of design rules, and wherein the fault rate provision unit is configured to calculate a plurality of fault rates for the plurality of design rules.

51. The system of claim 50, wherein the fault rate provision unit is configured to provide the plurality of fault rates in an m×l matrix, wherein the plurality of design rules comprise m design rules, wherein the plurality of layouts of interest comprise l layouts of interest, wherein m≧2, and wherein l≧2.

52. The system of claim 50, wherein the plurality of layouts of interest comprise a plurality of cell layouts selected from a standard cell library.

53. The system of claim 50, wherein the correction unit is configured to select a largest fault rate among the plurality of fault rates and suggest correction for one of the plurality of layouts of interest corresponding to the selected fault rate.

54. The system of claim 50, further comprising:
an area-based fault rate calculation unit configured to divide the plurality of fault rates by corresponding ones of a plurality of areas respectively corresponding to the plurality of layouts of interest to calculate a plurality of area-based fault rates.

55. The system of claim 54, wherein the area-based fault rate calculation unit is configured to determine a plurality of total area-based fault rates corresponding to the plurality of layouts of interest based on the plurality of area-based fault rates, and select one of the plurality of layouts of interest to be corrected based on the plurality of total area-based fault rates.

56. The system of claim 55, wherein the correction unit is configured to select a largest total area-based fault rate among the plurality of total area-based fault rates and suggest correction for one of the plurality of layouts of interest corresponding to the selected total area-based fault rate.

57. The system of claim 50, wherein the fault rate provision unit is configured to calculate a plurality of design rule-based total fault rates using the plurality of fault rates.

58. The system of claim 57, wherein the correction unit is configured to select a largest design rule-based total rate among the plurality of design rule-based total fault rates and suggest correction for one of the plurality of layouts of interest associated with one of the plurality of design rules corresponding to the selected design rule-based total fault rate.
